(19) United States
(12) Patent Application Publication
(10) Pub. No.: US 2020/0192133 A1
(43) Pub. Date: Jun. 18, 2020

(54) Tunable infrared spectral imager system

(71) Applicant: The Charles Stark Draper Laboratory, Inc., Cambridge, MA (US)

(72) Inventors: Christine Wang, Boston, MA (US); Matthew A. Sinclair, Stoneham, MA (US)

(21) Appl. No.: 16/454,977

(22) Filed: Jun. 27, 2019

Related U.S. Application Data
(60) Provisional application No. 62/693,727, filed on Jul. 3, 2018.

(51) Int. Cl. G02F 1/09; G02F 1/01

(52) U.S. Cl. CPC G02F 1/092; G02F 2203/055; G02F 1/0136

(57) ABSTRACT

A tunable imaging system capable of capturing both broadband and narrow band images is disclosed. The narrow band selection is made possible by constructing a spectral filter with a series of Faraday rotators and polarizers. The dispersion in Faraday Effect discriminates different wavelengths, allowing only light around the desired wavelength to pass through the polarizers. The central wavelength and/or the bandwidth of the filter can be tuned by varying the magnetic field and/or rotating the polarizers.

### RELATED APPLICATIONS

This application claims the benefit under 35 USC 119(e) of U.S. Provisional Application No. 62/693,727, filed on Jul. 3, 2018, which is incorporated herein by reference in its entirety.

### BACKGROUND OF THE INVENTION

Multi/hyper-spectral imaging combines imaging with spectroscopy, thus allowing for better detection and characterization of targets than conventional broadband imaging. Using different technologies, the imaging can extend across the ultraviolet (UV) to visible to infrared.

When images of different spectral bands are acquired from a common field of view (or a target), the best way to represent the entire data collection is to register all the images with each other and create a single image cube, e.g., hyperspectral cube, which is intensity as a function of the two-dimensional pixel coordinates and the spectral bands define the third dimension.

Multi; hyper-spectral imaging systems generally fall into either of two categories. Spatial scanning uses a two-dimensional image sensor that captures a slit spectrum (x,λ). A slit from the scene is dispersed with a prism or grating and projected onto the image sensor, then another slit from the scene is analyzed building up the scene in a push broom scan. Spectral scanning uses a tunable bandpass filter in front of the image sensor. Images are captured as the filter is tuned in order to build up the spectrum of the scene.

### SUMMARY OF THE INVENTION

A challenge in spectral scanning systems is the design of the tunable bandpass filter. One design uses a Fabry-Perot filter. The characteristics of the Airy function that defines the transmittance of this filter are specified by the reflectivity of and spacing between the mirrors of the Fabry-Perot filter. Typically, there are undesirable tradeoffs between passband characteristics and free spectral range of these filters.

Nevertheless, a multi/hyper-spectral imaging system covering the UV to visible to infrared would be a very powerful tool for standoff detection, identification, quantification, and/or autonomous system control. In addition to broadband analysis, selection of particular passbands by a wavelength tuning system would enable a camera system to sense presence of specific compositions of interest in an image by detecting specific absorption or emission bands. At the same time, it would also be desirable for the same system to generate grayscale images from all spectral bands to which the image sensor is sensitive.

The basic unit stage of the filter employed by the present system has two polarizers positioned at each end of an element constructed from a dispersive polarization-rotating medium, such as a magneto-optic (MO) medium. In this case, the dispersion is due to induced Faraday Effect caused by a typically tunable magnetic field B along the direction of the optical axis.

The first polarizer fixes all wavelengths of light from a target to be of a particular polarization. A dispersive rotating element rotates the polarization of different wavelengths of light by different amounts. The second polarizer is oriented such that its polarization axis coincides with the rotation of the desired wavelength, thus allowing it to pass to a subsequent stage. Typically, the two polarizers have their axes co-aligned, and the dispersive Faraday rotator and the magnetic field are tuned so that the polarization of the desired wavelength is rotated by multiples of 180° to pass through the second polarizer. It should be noted, however, that any angle between the two polarizers is possible and the angle of the polarizers may further be tunable.

If the polarization of all undesired wavelengths can be rotated equally to an angle, call it α°, different from the rotation of the desired wavelength, they can all be blocked out from passing through the second polarizer by having its polarization axis equal to 90°+α°. In reality different wavelengths will be rotated differently, proportional to B×V, where the Verdet constant V is a function of wavelength λ. Setting the second polarization axis equal to the rotation of the desired wavelength will still allow undesired wavelengths to pass through the polarizer but with diminished strength. The reduced strength will be proportional to cos² β, where β is the angle between the polarizations of rotated desired wavelength and rotated undesired wavelengths.

If the polarization of desired wavelength is rotated by multiples of 180°, which is taken to be the vertical axis, β becomes a λ-dependent angle from the vertical. To capture λ-dependency of β it can be designated as β(λ) which is a function λ, with β(λ_{desired})=0°.

The desired wavelength is nearly fully isolated by repeating the basic unit stage by adding additional dispersive element/polarizer pairs along the optical axis. The MO medium in each stage may vary in composition and/or optical length and/or experience different B-field strength. Each additional stage will result in further elimination of undesired wavelengths.

The isolation of the desired wavelength is achieved by applying the magnetic field to a certain strength, and the central wavelength and passband width can be adjusted by tuning the magnetic field strength.

The dispersive elements, e.g., Faraday rotators, can be fabricated from materials such as terbium—gallium garnet crystals (TGG) and terbium-doped borosilicate glass and yttrium iron garnet (YIG), to list a few examples.

For long wave infrared (LWIR), potential materials for the dispersive Faraday rotators include narrow bandgap semiconductors such as indium antimonide (InSb) and indium arsenide (InAs), garnets and chalcogenide glasses.

In general, according to one aspect, the invention features an optical filter comprising a dispersive polarization-rotating medium, wherein the filter is a spectral filter.

Often there is a lens or a multi-lens system to collect from an emission source, followed by a polarizer to fix the polarization of the incoming light. Next are one or a series of a dispersive polarization-rotating media comprising magneto-optic material such as Faraday rotators and polarizers to select the desired wavelength. The B-field for each medium and/or tilt of the polarization axis of each polarizer are chosen as described above. Finally, at the end of the last polarizer a focal plane array records the image.

In general, according to another aspect, the invention features a tunable spectral filter comprising one or more stages of polarizers and dispersive magneto-optic material and a tunable magnetic field source generating a magnetic field, wherein the central wavelength and/or the bandwidth is tuned by the magnetic field.

The magnetic field source might be an electromagnetic source and the magnetic field strength is tuned electrically or permanent magnets and the magnetic field is tuned by varying the distance between the magnets and the materials. The magnetic field source could also comprise a combination of electromagnets and permanent magnets and entail magnetic thin films deposited on the magneto-optic materials, and the magnetic field is tuned by electromagnets or permanent magnets.

In some cases, the central wavelength of the filter is tuned by the angle of one or more polarizing elements.

In general, according to another aspect, the invention features tunable spectral filter comprising one or more stages of polarizers and dispersive polarization-rotating media, wherein the central wavelength and/or the bandwidth of the filter is tuned by the angle of one or more of the polarizers.

In general, according to another aspect, the invention features an optical system comprising a tunable spectral filter including one or more stages of polarizers and dispersive magneto-optic materials and a tunable magnetic field source generating a magnetic field for the dispersive magneto-optic materials. A central wavelength and/or a bandwidth of the filter is tuned by the magnetic field.

Typically, the optical system will comprise collection optics including lenses and/or mirrors for collecting light for filtering by the tunable spectral filter and/or active light sources including lasers and/or lamps for illuminating a scene.

In some cases, one or more photodetectors for detecting light from the filter. Usually se are more focal plane arrays (FPA).

Reflective polarizers and multiple focal plane arrays can be used for detecting light at the different stages of the filter.

In general, according to another aspect, the invention features an optical system comprising a tunable spectral filter including one or more stages of polarizers and dispersive polarization-rotating media. The central wavelength and/or the bandwidth of the filter is tuned by the angle of one or more of the polarizers.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic side view of the imaging system employing a filter according to the present invention.

FIG. 1A is a schematic diagram showing a detection assembly that replaces the focal plane array of FIG. 1 when multiple detectors are employed to cover the spectral band of interest.

FIG. 2 illustrates how a dispersive polarization-rotating MO medium (Faraday, rotator) in combination of polarizers filters light.

FIG. 3A is an illustrative plot of β versus wavelength for λ₁, λ₂ and λ₃ in FIG. 2.

FIG. 3B is an illustrative plot of cos²β versus wavelength for λ₁, λ₂ and λ₃ in FIG. 2.

FIG. 4A is a schematic side view showing a current carrying solenoid around the MO medium to generate the B field.

FIG. 4B is a plot of intensity as a function of wavelength illustrating the tuning of the filter wavelength by the B field.

FIG. 5 is a schematic side view of an n-stage filter showing the alternating arrangement of n+1 polarizers and n dispersive elements, e.g., Faraday rotators, where n can be any integer from 1 to 10, or to 20 or more.

FIG. 6 is a schematic side view of a three-stage version of the filter where all the polarizers are aligned in the same direction. With the B field properly chosen, the Faraday rotator in each stage n rotates the polarization of the desired wavelength by n×180°; in one example.

FIG. 7 has four plots of transmittance as a function of wavelength (micrometers) showing no transmission loss when B=0 for the filter of FIG. 6, showing a non-spectral resolving imaging mode. The first plot is of transmittance T₁ due to the first Faraday rotator and polarizer pair. The second plot of transmittance T₂ is due to the second pair. The third plot of transmittance T₃ is due to the third pair. The last one is transmittance of all three stages combined; total transmittance=T₁×T₂×T₃. Total transmittance is the transmittance upon exit from the filter.

FIG. 8 shows transmittance versus wavelength plots T₁, T₂ and T₃ due to each three stages of rotator and polarizer with V∝λ² and non-zero B-field for the filter of FIG. 6 showing a spectral resolving imaging mode. The last curve is the total transmittance upon exit from the filter. The value of B-field, same for all Faraday rotators is chosen to select k=12 μm.

FIG. 9 shows transmittance versus wavelength plots T₁, T₂ and T₃ due to each three stages of rotator and polarizer with V∝λ² and non-zero B-field for the filter of FIG. 6 showing a spectral resolving imaging mode. The last curve is the total transmittance upon exit from the filter. The value of B-field, same for all rotators is chosen to select λ=10 μm.

FIG. 10 shows narrowing of peaks of transmittance vs wavelength plots T₂ and T₃ by using a B-field twice the strength as in FIG. 9 with V∝λ². It also shows total transmittance.

FIG. 11 shows transmittance plots with V∝λ² and B chosen to select λ=8 μm. This results in an unwanted peak around λ=11 μm.

FIG. 12 is a schematic side view of a four-stage filter that will mitigate the unwanted peak in FIG. 11. In contrast to FIG. 6, a perpendicular polarizer and a Faraday rotator with half the rotating power of L₁ in FIG. 6 are used at the outset (immediately after the emitting target) in this embodiment.

FIG. 13 shows the elimination of the unwanted peak around 11 μm using the four stage filter of FIG. 12. This is seen by examining total transmittance plot (the last curve). T₀, T₁, T₂ and T₃ are due to each pair of rotator and polarizer that follow the first polarizer (perpendicular orientation). The last curve is the total transmittance upon exit from the filter.

FIG. 14 is a schematic side view of another example of a three-stage filter where the 4 polarizers are crossed alternatively, 0°, 90°, 0°, 90° axis orientations. The three Faraday rotators rotate the polarization of the desired wavelength by 90°, 270° and 450°, respectively.

FIG. 15 shows the transmittance through the filter stages of FIG. 14 when B=0. The transmittances T₁, T₂, T₃ and the total transmittance are all zero.

FIG. 16 shows transmittance plots T₁, T₂ and T₃ due to each stage of Faraday rotator and polarizer with V∝λ² with non-zero B-field for the embodiment of FIG. 14. The last curve is the total transmittance upon exit from the filter. The value of B-field, same for all rotators is chosen to select λ=12 μm.

FIG. 17 shows transmittances for letting λ=10 μm pass with V∝λ² by using appropriate magnetic field for the embodiment of FIG. 14.

FIG. 18 shows transmittances for λ=10 μm when B is three times stronger than that used in FIG. 17 for the embodiment of FIG. 14.

FIG. 19 is a schematic side view of a three-stage filter where the central wavelength of the filter is tuned by rotating the polarizers P₁, P₂ and P₃.

FIG. 20 shows the transmittance through the filter stages of FIG. 19 when the polarizers are rotated to select λ=12 μm.

FIG. 21 shows the transmittance through the filter stages of FIG. 19 when the polarizers are rotated to select λ=10 μm.

FIG. 22 is a schematic side view of another embodiment of this invention where dispersive birefringent materials are added to the filter stages to reduce the magnetic field strength requirement.

FIGS. 23A and 23B show the use of specialized filters to pass through selected spectral band of light.

FIG. 24 is a schematic side view of another embodiment of the imaging system that uses a reflective front polarizer that is tilted from normal to reflect partially the unfiltered light to form a simultaneous broadband image in addition to the final filtered image.

FIG. 25 is a schematic side view of another embodiment of the imaging system that uses reflective polarizers that are tilted from normal, to reflect partially filtered light from each of the stages for intermediate images in addition to the final filtered, all of which are simultaneously captured. Here the initial polarizer reflects light to a focal plane array (FPA) for a broadband image. Similarly, the next three polarizers reflect light to corresponding FPAs for three additional mages. The remainder of unreflected light is imaged as before by an FPA as in previous embodiments.

FIG. 26 shows the schematic side view of another embodiment that undoes image distortion caused by the rotators by using an opposing magnetic field and a medium that is the sum total (in thickness) of individual rotators.

FIG. 27 is a schematic side view of the cal system corresponding to the primary embodiment of FIG. 5.

FIG. 28 shows the Verdet constant, degrees/mm.Tesla, as a function wavelength in micrometers, in which the dots are measured data and the dashed line is the quadratic fitting of the data.

FIG. 29 shows plots of transmittance as a function of B field for an experimental demonstration of a 3-stage filter with a laser at fixed wavelength λ=11 μm while scanning the B field.

FIG. 30 are plots of transmittance as a function of B field for an experimental demonstration of a 3-stage filter with a laser at fixed wavelength λ=11 μm while B=0.5 Tesla.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

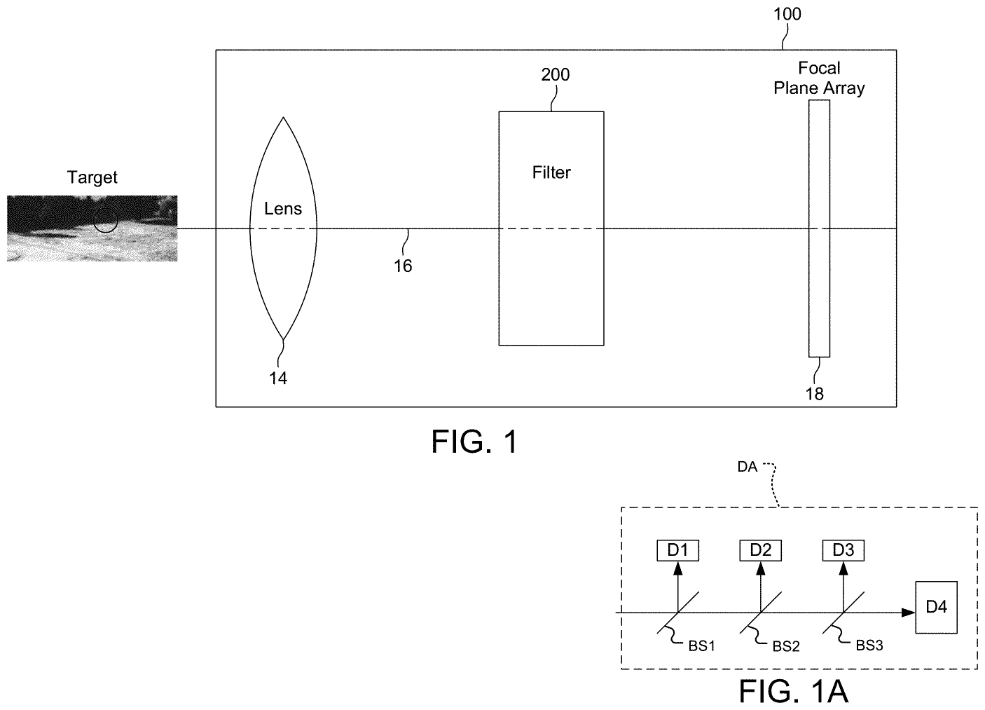

FIG. 1 is a block diagram of the imaging system 100 with optical axis 16. Emitted light from the target enters filter 200 after being collected and collimated by the collection optics 14. Lenses, reflective optics, and combinations of lenses and mirrors (catadioptric systems) could be used to collect the light. The filter 200 can both pass through unchanged broadband light to an FPA 18 (Focal Plane Array) or select a particular wavelength for imaging on FPA 18. The goal is to obtain the spectrum for each pixel in the image of a scene, with the purpose of finding objects, identifying materials, or detecting processes, for example.

In one embodiment, the FPA 18 is a two-dimensional spatially resolved microbolometer array. With current technology, the array might have 320×240 pixels or 160×120 pixels. Newer arrays have higher levels of integration such as 640×480 or 1024×768 pixels. In another embodiment, the EPA 18 is a two dimensional array made from HgCdTe (MCT) detector material.

In other embodiments, the FPA 18 employs other image sensor technologies. Other examples include semiconductor charge-coupled devices (CCD) or active pixel sensors in complementary metal-oxide-semiconductor (CMOS) or N-type metal-oxide-semiconductor (NMOS, Live MOS) technologies.

In another example, the FPA 18 is replaced with a detection assembly DA, shown in FIG. 1A.

Here the visible is split off by a first beamsplitter BS1, which only reflects the visible, to the visible image sensor FPA D1. Shortwave infrared/near infrared (SWIR/NIR) light is split off by a second beamsplitter BS2, which only reflects the SWIR/NIR to the SWIR/NIR image sensor FPA D2, The mid-wave infrared (MWIR) is split off by a third beamsplitter BS3, which only reflects the MWIR, to the MWIR image sensor D3. Finally, the LWIR passes through all the beamsplitters BS1-BS3 to the LWIR image sensor D4.

In one example, a visible image sensor D1 has at least 1600×1200 pixel focal plane array and is a CMOS image sensor.

A SWIR image sensor D2 has at least a 640×512 InGaAs image plane pixel array.

A MWIR image sensor D3 is a HgCdTe detector with an integrated dewar cooler assembly. One example has 1280×720, with a 12 μm pitch, focal plane pixel array.

A LWIR image sensor D4 is a 12 μm pitch vanadium oxide (VOx) uncooled detector, having at least a 640×512 or 320×256 focal plane pixel array.

Often, the focal points F1-F4 are spatially separated from each other by creating different beam paths with dichroic filter beamsplitters of a detection assembly DA.

By tuning the filter 200 and capturing images of the scene at different wavelengths, the spectrum at each pixel is obtained. Each image represents a narrow wavelength range of the electromagnetic spectrum, also known as a spectral band. These ‘images’ are often combined to form a three-dimensional, in (x,y,λ), hyperspectral data cube for processing and analysis, where x and y represent two spatial dimensions of the scene, and) represents the spectral dimension (comprising a range of wavelengths).

The system relies on rotating the polarization of light in a dispersive fashion and then filtering or isolating the desired wavelengths by using polarizers. Since in a dispersive medium different wavelengths have different phase velocities and are thus rotated by different amounts per unit length, by proper placement and orientation of a polarizer, the desired wavelength passes through the polarizer with negligible attenuation while other wavelengths pass through with much larger attenuation. Repeated uses of dispersive rotation and polarization finally eliminates the undesired wavelengths and the desired wavelength of light passes through the filter.

More specifically, the polarization-rotating medium is made of magneto-optic (MO) materials which rotate the polarization of light under magnetic field by the amount θ=VBl where B=magnetic field, l=length of the material, and V is the Verdet constant. This is called the Faraday Effect. The Verdet constant is characteristic to the material used and is wavelength-dependent.

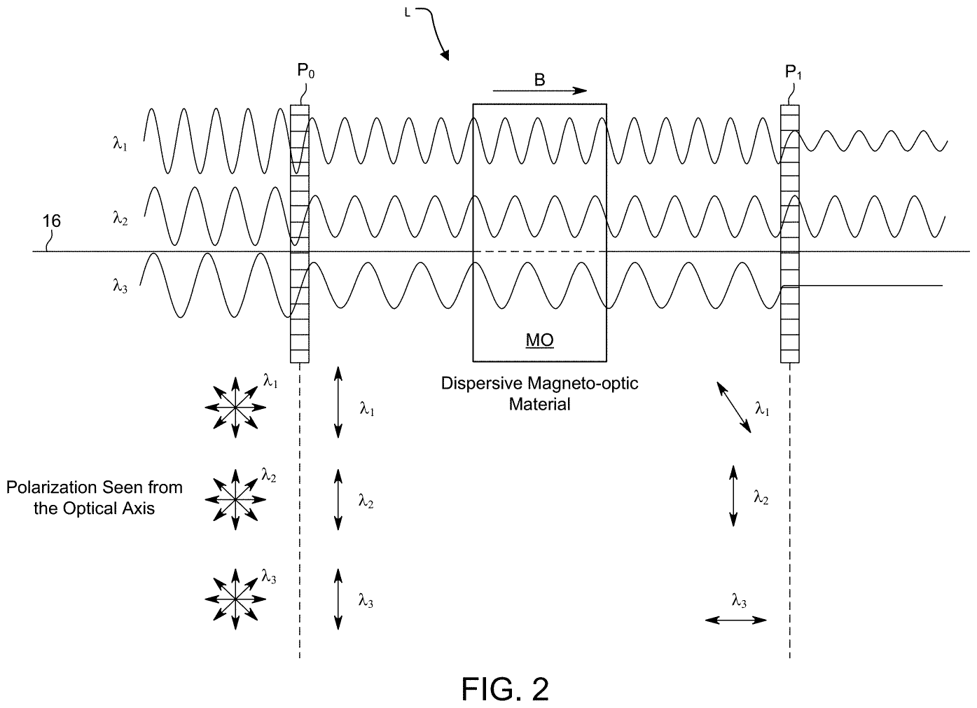

FIG. 2 illustrates one unit stage of the filter and the principle of light filtering. The unit stage comprises a front polarizer P₀, a dispersive MO medium and a back polarizer P₁. The arrows indicate polarization of light on a plane perpendicular to the plane of the figure as viewed from left to right along the optical axis 16. Light that is composed of different wavelengths λ₁, λ₂ and λ₃ first get polarized by the front polarizer P₀. For completely unpolarized incoming light, the front polarizer would cut the optical power by 50%. Under magnetic field B, the polarizations of λ₁, λ₂ and λ₃ get rotated to different amounts due to the dispersive property of the MO medium of the dispersive element L. In this illustration, both the front and back polarizer axes are aligned to the vertical. The polarization of λ₂ is rotated back to the vertical axis and thus it passes through the back polarizer, whereas the polarization of λ₃ is rotated to the horizontal axis and thus blocked by the back polarizer. The polarization of λ₁ is rotated to somewhere in the middle and thus it partially passes through.

The dependence on λ of V(λ) depends on the physical mechanism of the Faraday Effect in the material. For example, highly doped semiconductors are expected to have V∝λ²; see, e.g., Hilco et al, “Note: A high transmission Faraday optical isolator in the 9.2 μm range”, Review of Scientific Instruments, 82, 096106 (2011), Other paramagnetic materials such as Pr-doped TGG have

$$V ∝ \frac{1}{{λ}^{2} - {λ}_{0}^{2}} ;$$

see e.g., “wavelength dependence of Verdet constant of Pr-doped terbium gallium garnet crystal”, Optical Materials 62 (2016) 475-478.

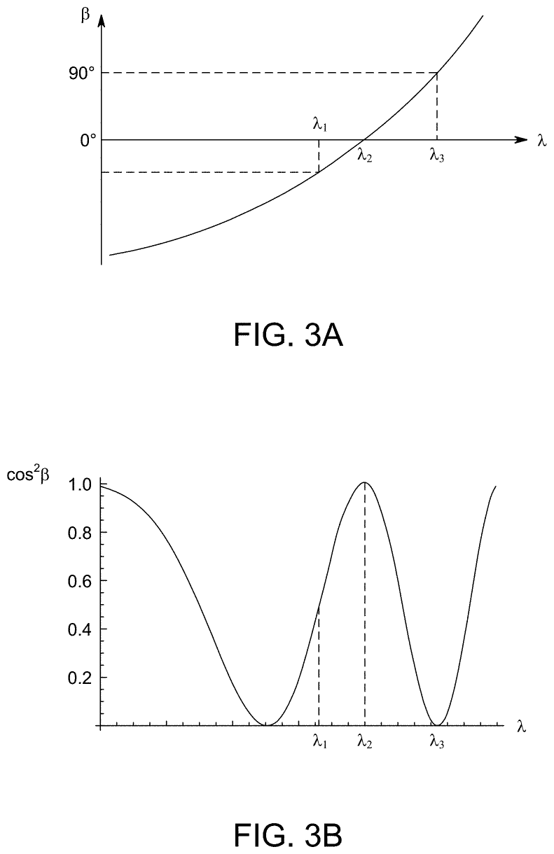

Assuming V∝λ² and defining β to be the angle of light polarization from vertical, FIG. 3A illustrates β versus λ for λ₁, λ₂ and λ₃ in FIG. 2. In this case β(λ₁)=135° or −45°, β(λ₂)=0°, whereas β(λ₃)=90°. The amount of light that can pass through the back polarizer in FIG. 2 is proportional to cos²β, which is plotted in FIG. 3B.

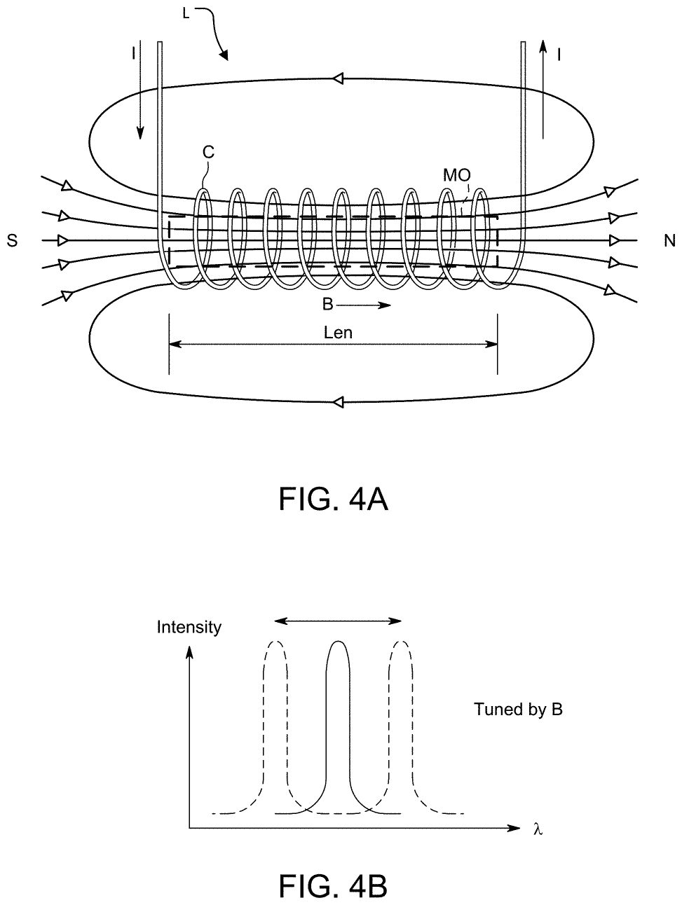

FIG. 4A shows a dispersive element L. It shows one way of generating a nearly uniform magnetic field by placing the magneto-optic medium MO of length LEN inside a Helmholtz coils C with current I. The magnetic field strength is proportional to the current I. Changing the B field strength (by changing the current I) changes the wavelength that can pass through the filter, as illustrated in FIG. 4B.

The magnetic field source can also be permanent magnets and the field strength is tuned by varying the distance between the magnets and the materials. It can also be a combination of electromagnets and permanent magnets.

The magnetic field source can also be magnetic thin films deposited on the magneto-optic materials, and the field strength is tuned by external electromagnets or permanent magnets.

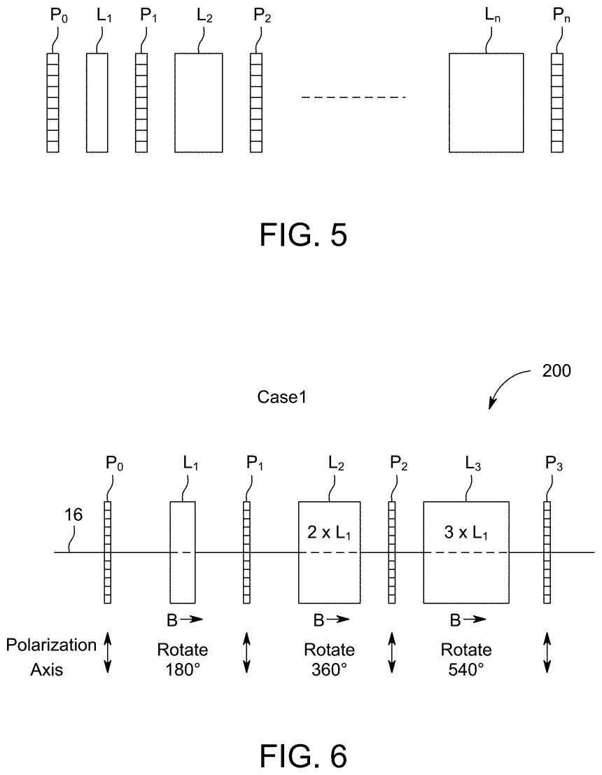

FIG. 5 shows one embodiment of the filter 200 having n stages of the unit illustrated in FIG. 2. The number of stages n can be any integer from 1 to 5 or 10 or 20, or more. The unwanted wavelengths are further attenuated through each stage, resulting in a narrower passband around the desired wavelength. In each stage, the MO medium length of dispersive element L, composition and/or the magnetic field strength may vary. The polarizers can be orientated to any direction depending on the filter design and/or desired passband.

FIG. 6 shows one example of the embodiment of the filter in FIG. 5. In this 3-stage filter; an initial polarizer P₀ is followed by 3 stages of dispersive elements L, such as Faraday rotators, polarizer pairs: (first dispersive rotator element L₁, first filtering polarizer P₁); (second dispersive rotator element L₂, second filtering polarizer P₂); and (third dispersive rotator element L₃, third filtering polarizer P₃).

In the illustrated embodiment, all of the dispersive elements L₁-L₃ are subject to same magnetic field B pointing to the right, parallel to the optical axis 16. All polarizers have their axes vertically oriented. The dispersive elements L₁, L₂ and L₃ are of similar composition but of different lengths: L₂ and L₃ are 2 and 3 times longer than L₁, respectively. Thus dispersive elements L₂ and L₃, as expected from the same Verdet constant, cause 2 and 3 times as much of polarization rotation as L₁ in the presence of the same magnetic field.

In other embodiments, however, different dispersive elements of different materials and/or different lengths could be used. Moreover, different magnetic fields/coils could be used for each of the dispersive element L₁-L₃ so that the magnetic field that is applied to each element is unique and separately controlled for that element.

Note that in this embodiment all the polarizers have their axes aligned in the vertical, but their axes can be all tilted from vertical by the same angle φ; the filter's behavior would be exactly the same in spite of φ.

The magnitude of the B-field is tuned to rotate the desired wavelength by 180° by dispersive element L₁, 360° by dispersive element L₂ and 540° by dispersive element L₃. Thus, since the polarizer axes are vertical in the illustrated example, the desired wavelength, upon exiting the dispersive rotators L₁-L₃, will pass through the polarizers without further attenuation.

Note that in other embodiments where all the polarizers are aligned in the same direction, L₁, L₂ and L₃ can rotate the polarization of the desired wavelength by m×180°, where m can be any arbitrary integer.

The total transmittance of light upon emergence from polarizer P₃ is given by the product of T₁, T₂ and T₃, where Tᵢ denotes the transmittance through each unit stage composed of dispersive element Lᵢ and polarizer Pᵢ, i=1, 2 and 3. Tᵢ is calculated the same way as we calculate the amount of light passing through a unit stage in FIG. 2, by computing cos²β(λ) as in FIG. 3B.

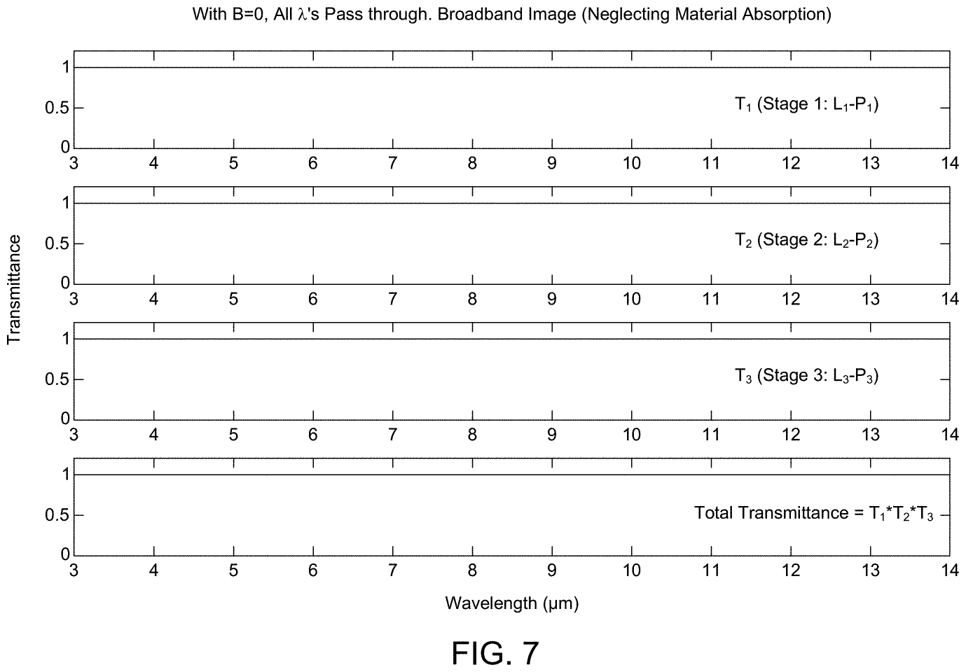

FIG. 7 shows the transmittances (T₁, T₂ and T₃) versus wavelength of the three stages, i.e., (rotator, polarizer)-pair, and the final value when the B-field is turned off. Since there is no rotation of light with B=0, the polarizations of all wavelengths through the Faraday rotators remain unchanged. Thus, T₁=T₂=T₃=1. Finally, the total transmittance=T₁×T₂×T₃ also is unity. In this mode of operation, the system operates as a grayscale imager.

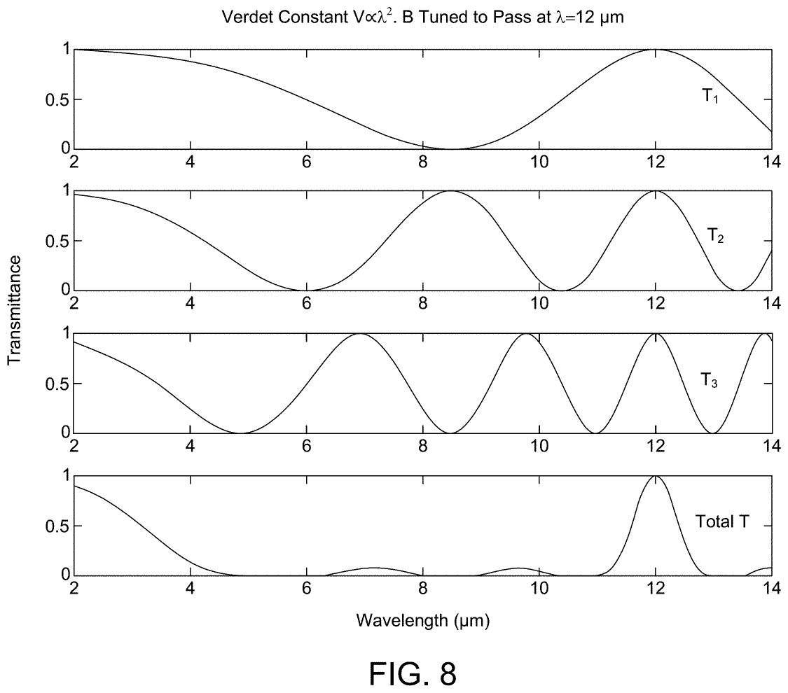

FIG. 8 shows the transmittances versus wavelength for the embodiment in FIG. 6 when the B-field is tuned to pass light around λ=12 μm, assuming V∝λ² as in highly doped semiconductors. Due to the different lengths of dispersive elements L₁, L₂ and L₃, the amount of rotation experienced through each stage is different, resulting in the different shapes or free spectral ranges (FSRs) of T₁, T₂ and T₃. T₂ has twice as many peaks and valleys or half the FSR as T₁ across the same wavelength range, whereas T₃ has three times as many peaks and valleys or a third FSR as T₁. The thinnest stage T₁ sets the transmission peaks within the wavelength range, and the thicker stages T₂ and T₃ further narrow down the transmission peaks.

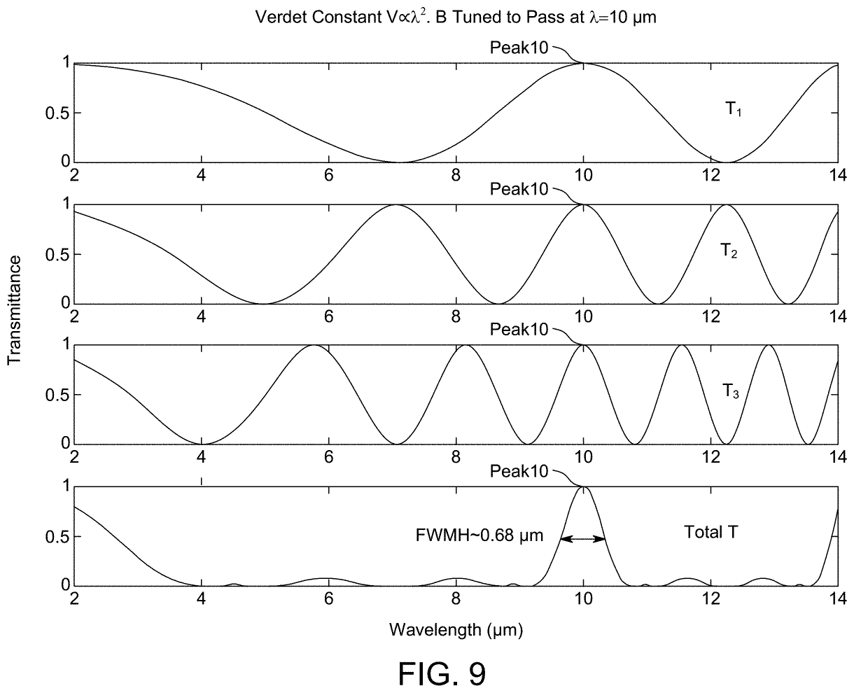

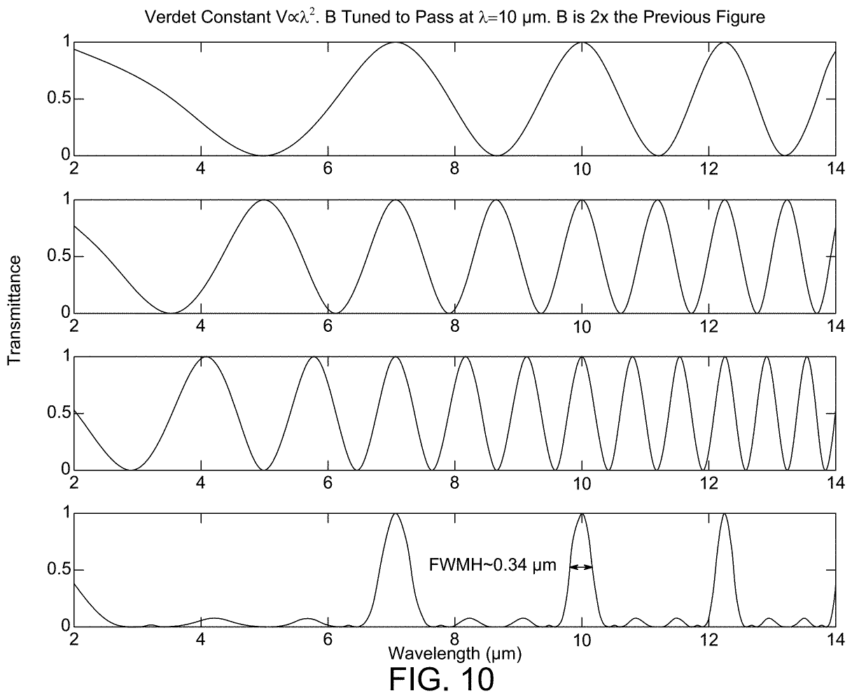

FIG. 9 shows the transmittances versus wavelength for the embodiment of FIG. 6 when the B-field is tuned to pass light around λ=10 μm, assuming V∝λ² as in highly doped semiconductors.

Note that any of the stages i=1, 2, 3 can be omitted at the risk of wider peaks at the desired wavelength.

Additional stages (Faraday rotator and polarizer pairs) can be added to filter design if further narrowing of the transmission peak is desired.

FIG. 10 shows results for a B-field which is twice as strong as that in FIG. 9. Recall that angle of rotation, θ=VBL, is proportional to B. Thus T₁, T₂ and T₃ have twice as many peaks and valleys, filter orders, as the corresponding transmittance plots in FIG. 9, Notice that the transmission peak at λ=10 μm is about half as narrow as in FIG. 9.

FIGS. 8 through 10 illustrate that the central wavelength of the passband as well as the passband width of the filter can be tuned by the B-field. Note that although the transmittance curves are plotted assuming the Verdet constant of the dispersive elements has wavelength dependence V∝λ², this is applicable to any other wavelength dependence.

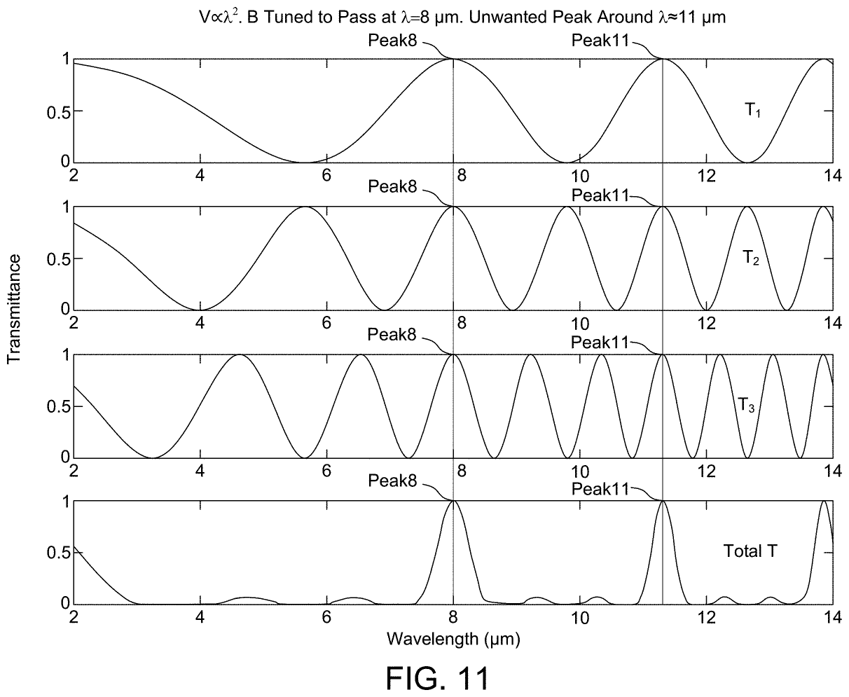

FIG. 11 shows the transmittances for the embodiment of FIG. 6 for isolating λ=8 μm, assuming V∝λ². The key observation is that in LWIR region of 8-12 μm, there is an unwanted transmittance peak Peak11 at around 11 μm, in addition to the desirable peak Peak8 at 8 μm.

Unwanted transmittance peaks can be eliminated by adding additional stages which create transmission minimum at the unwanted wavelength while maintaining transmission maximum at the desired wavelength or a simple cut-off spectral filter could be used.

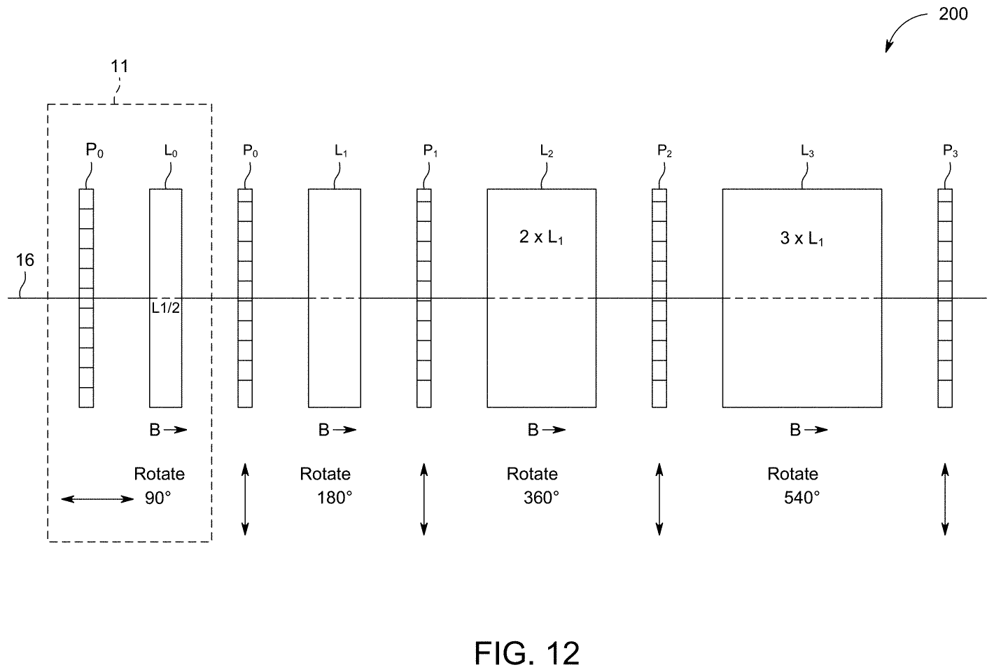

FIG. 12 shows a four stage filter 200 configuration to eliminate the unwanted. Peak11 in FIG. 11. The embodiment, is a modification of the embodiment of FIG. 6. The modification, shown in box 11 to the left of P₀ and immediately after the emitting target, includes a polarizer P₀′ perpendicular to co-aligned P₀, P₁, P₂, and P₃, and a dispersive element L₀, which is half the length of dispersive element L₁.

The four stages of the filter are the four dispersive element and polarizer pairs: (L₀, P₀), (L₁, P₁), (L₂, P₂) and (L₃, P₃).

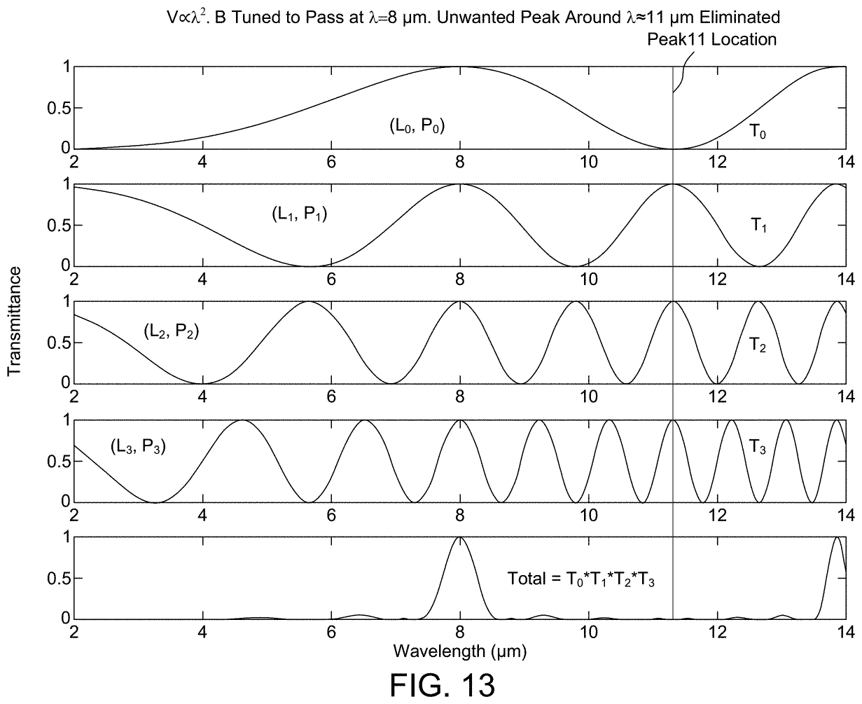

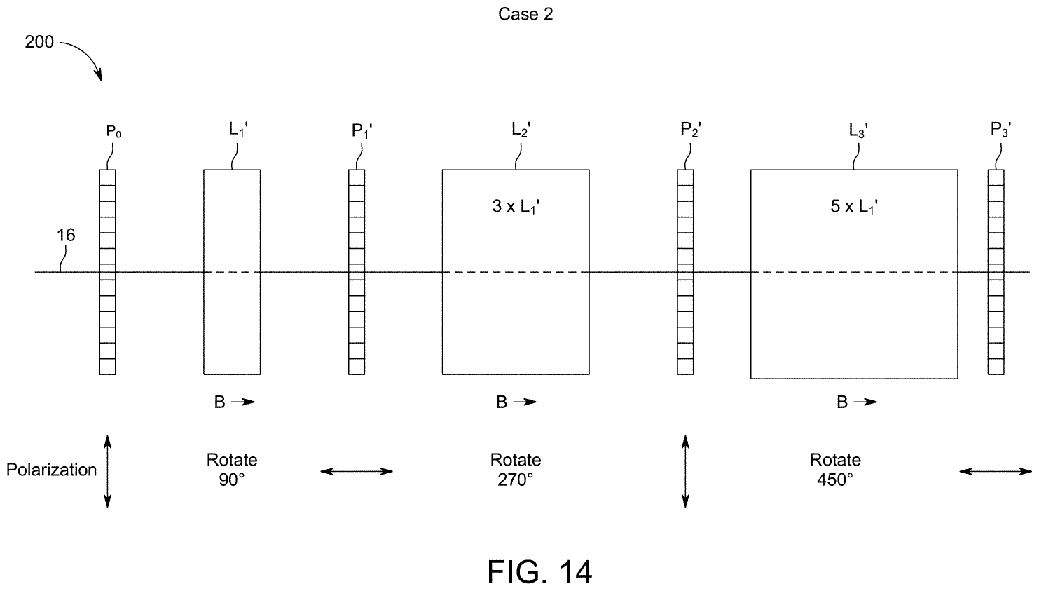

FIG. 13 shows the transmittance plots for the embodiment shown in FIG. 12. P₀′ initially sets the polarization angle of light orthogonal to polarizers P₀, P₁, P₂ and P₃. In addition to the T₁, T₂ and T₃ transmittance plots in FIG. 12, there is a new transmittance plot T0 which is due to L0 and P0. T0 shows the transmittance plot for orthogonally polarized light from P₀′ passing through L₀ and P₀, which is zero around the location of Peak11. Note that the T₁, T₂ and T₃ curves are exactly the same as in FIG. 10 since the polarization of light impinging on dispersive element L₁ is exactly same as in FIG. 4 and (L₁, P₁); (L₂, P₂); and (L₃, P₃) pairs are exactly the same as before. However the total transmittance=T₀×T₁×T₂×T₃ has no peak at Peak11 location because T0 is zero at that location.

FIG. 14 is an alternate example of the embodiment in FIG. 5. Like Case 1 shown in FIG. 6, this embodiment contains 3 stages of (dispersive element, polarizer)-pairs after the initial vertical polarizer P₀. In this case, however, the polarizers, P₀, P₁′, P₂′, and P₃′, are crossed alternatively instead of being all aligned in the same vertical direction as in FIG. 6. Similar to the case in FIG. 6, only the relative angles between the polarizer axes matter; their absolute angles with respect to the vertical do not affect the filter's behavior.

The dispersive Faraday rotator elements L₁′, L₂′ and L₃′ rotate the polarization of desired wavelength by 90°, 270° and 450°, respectively. Since the polarizers are crossed alternatively, the desired wavelength will pass through all the polarizers after rotation.

Note that in other embodiments where the polarizer axes are chosen to be crossed alternatively, dispersive element L₁′, L₂′ and L₃′ can rotate the polarization of the desired wavelength by m′×90° where m′ is any odd integer.

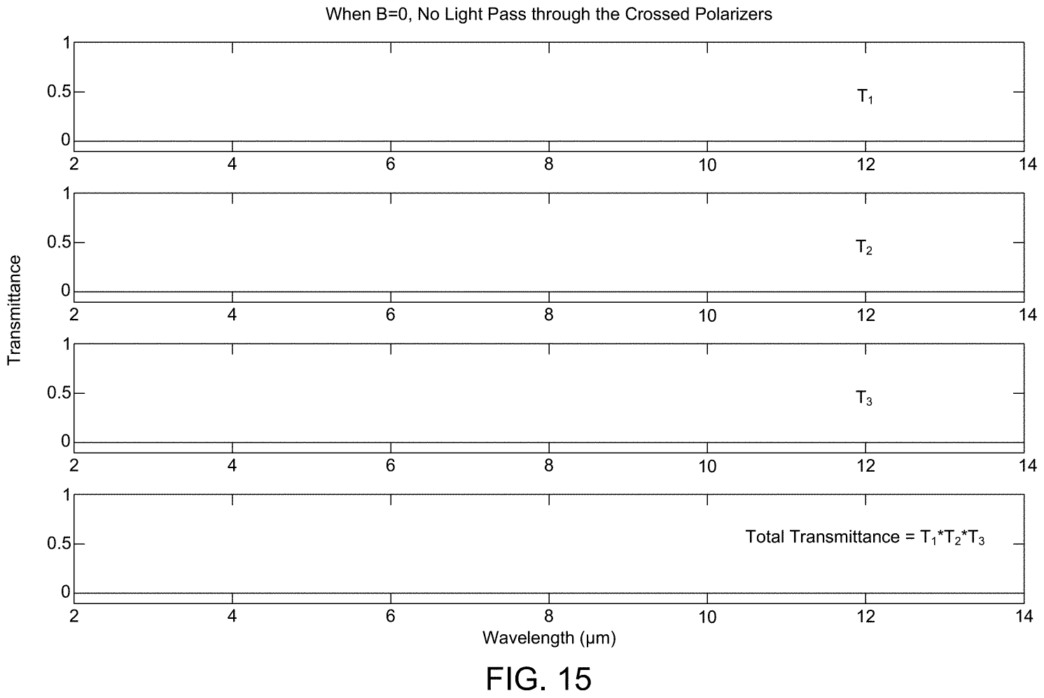

FIG. 15 shows transmittance plots (T₁, T₂ and T₃) for the pairs of rotators and polarizers when B-field is turned off. At B=0, the polarization rotations from L₁′, L₂′ and L₃′ are all zero, thus light is blocked by the crossly aligned polarizer pairs (P₀, P₁′), (P₁′, P₂′) and (P₂′, P₃′). Hence T₁, T₂ and T₃ as well as the total transmittance are all zero.

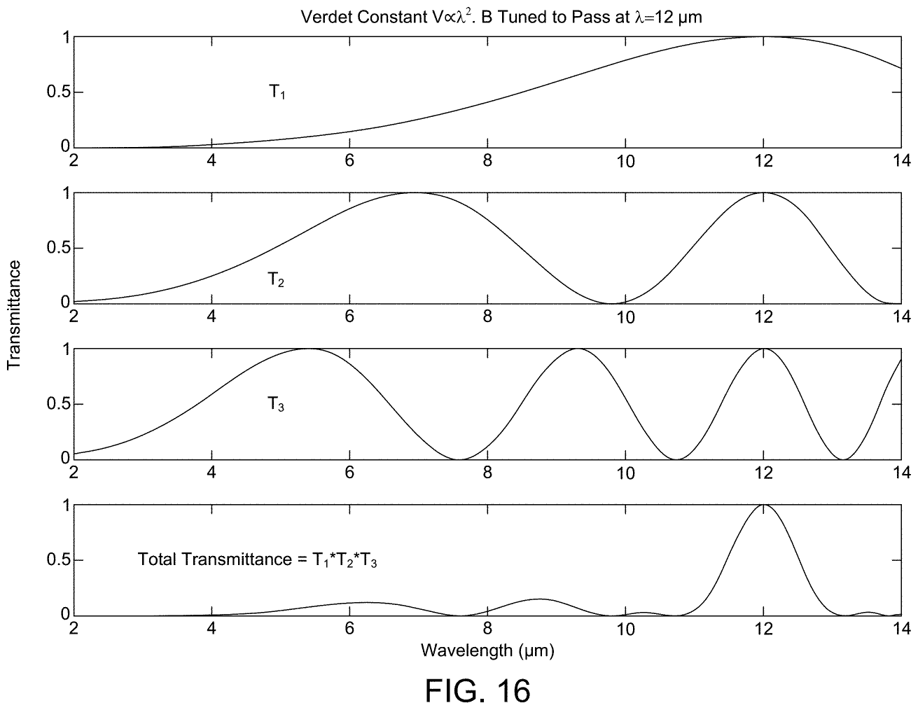

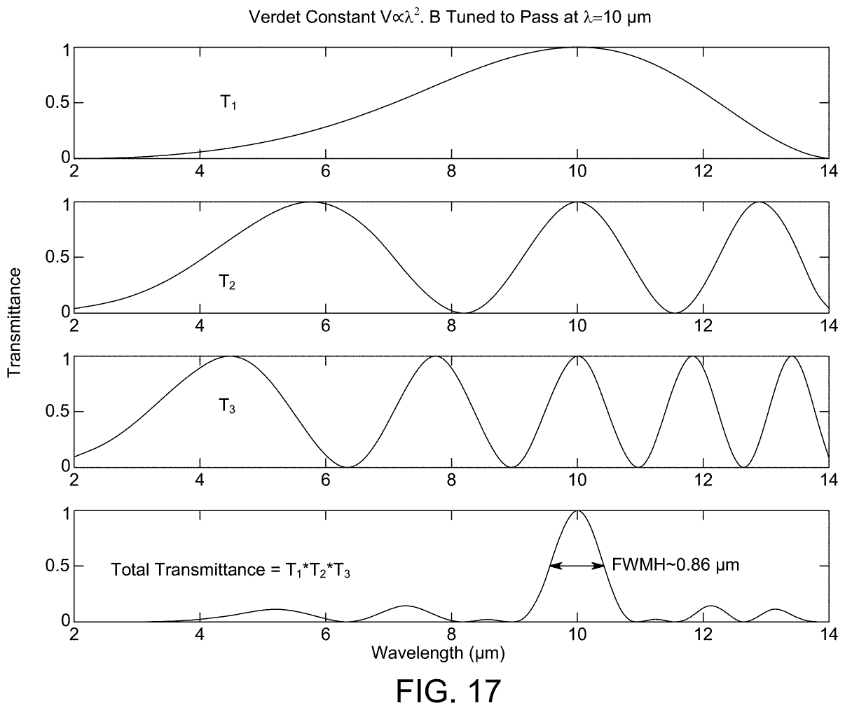

FIGS. 16 and 17 show resulting transmittance plots when the B-field is tuned to let 12 μm and 10 μm wavelengths pass through, respectively; for the embodiment of FIG. 14.

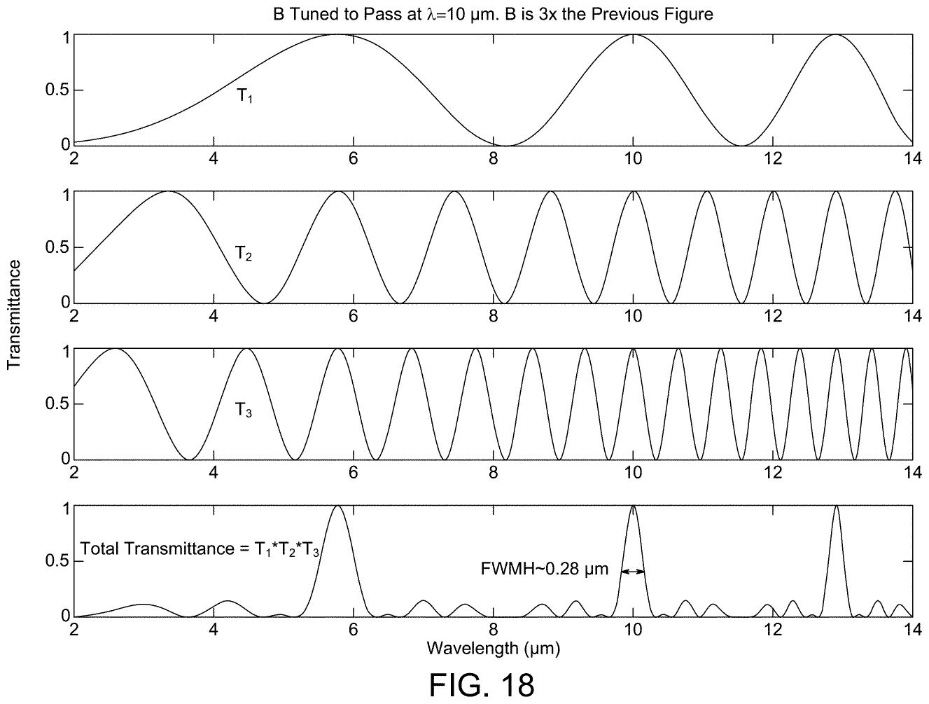

FIG. 18 shows transmittance plots for embodiment of FIG. 14 when the B-field is tuned to pass through 10 μm wavelength as in FIG. 17. The difference here is that B field is 3 times stronger than that of FIG. 17, resulting in 3 times as many peaks and valleys in the transmittance curves and a transmission peak at 10 μm that is about one third of the width as in FIG. 17.

In addition to tuning the filter 200 by varying the magnetic field of the dispersive elements, an alternative way to tune the filter is to rotate the polarizers while applying a constant or slowly-varying magnetic field to the dispersive elements. The magnetic field provides a constant or slowly-varying polarization dispersion, and the polarizers are rotated to align their axes to the polarization of the target wavelength.

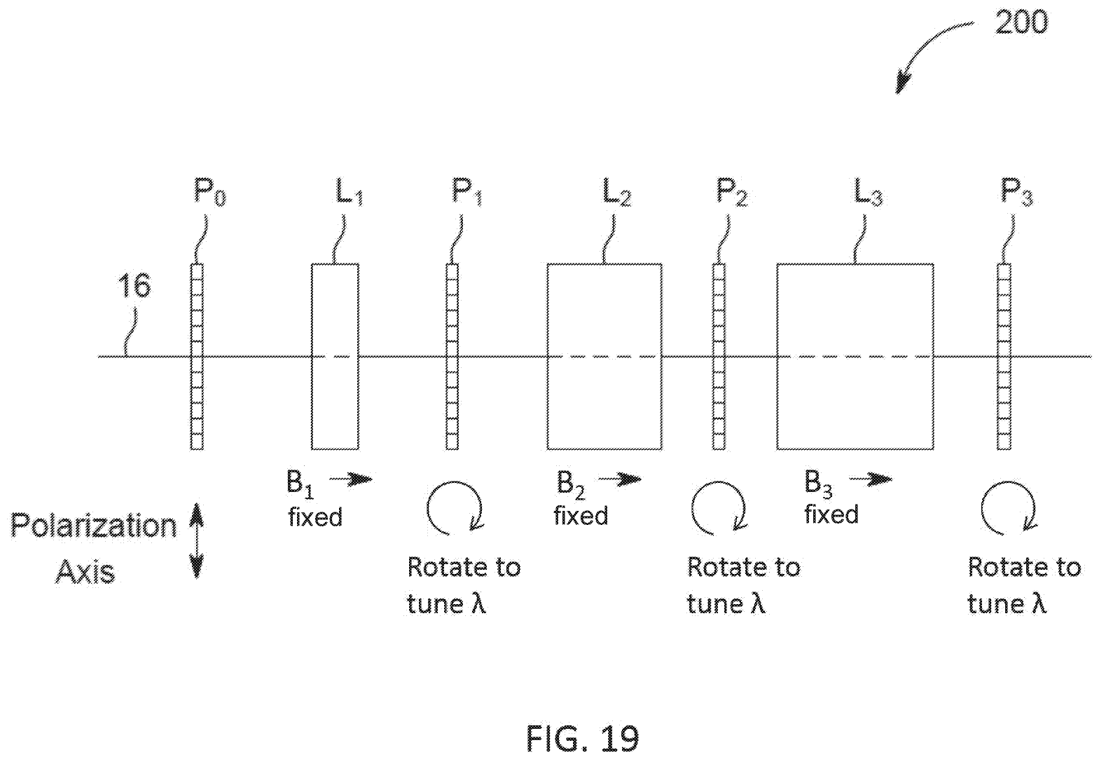

FIG. 19 shows one embodiment of the filter 200 in which the central wavelength is tuned by rotating the polarizers P₁, P₂ and P₃. In this 3-stage filter configuration, the magnetic fields B₁, B₂ and B₃ that each dispersive element L₁, L₂ and L₃ experiences are kept constant. The initial polarizer P₀ sets the polarization of incoming light, and the following polarizers P₁, P₂ and P₃ are rotated to tune the central wavelength of the filter 200.

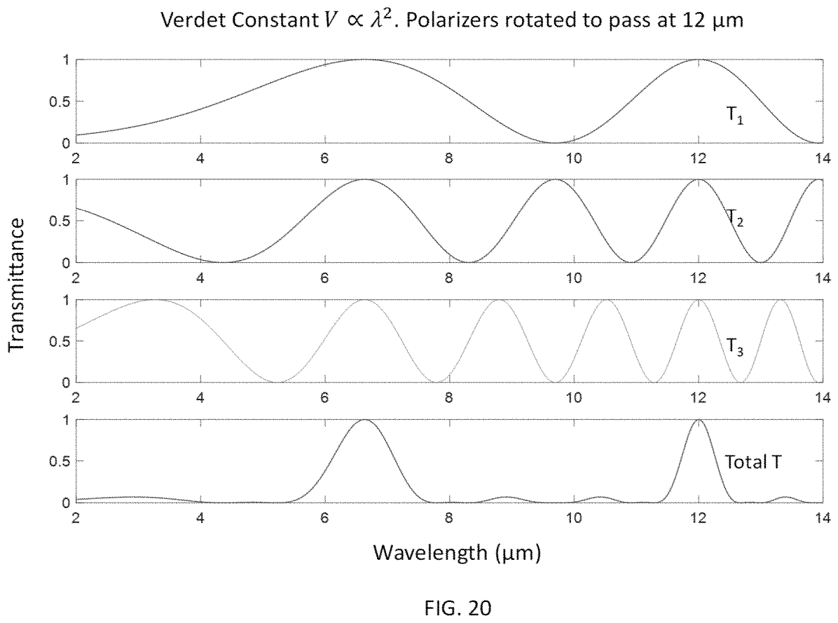

FIG. 20 shows the transmittances versus wavelength for the embodiment in FIG. 19 when the polarizers are rotated to pass light around λ=12 μm, assuming V∝λ² as in highly doped semiconductors. It is assumed that the combination of (B₁, B₂, B₃) and (L₁, L₂, L₃) are chosen so that the first stage rotates light polarization by the amount θ₁=aλ², the second stage rotates light polarization by the amount θ₂=2aλ², and the third stage rotates light polarization by the amount θ₃=3aλ², where a=π/100 rad/μm².

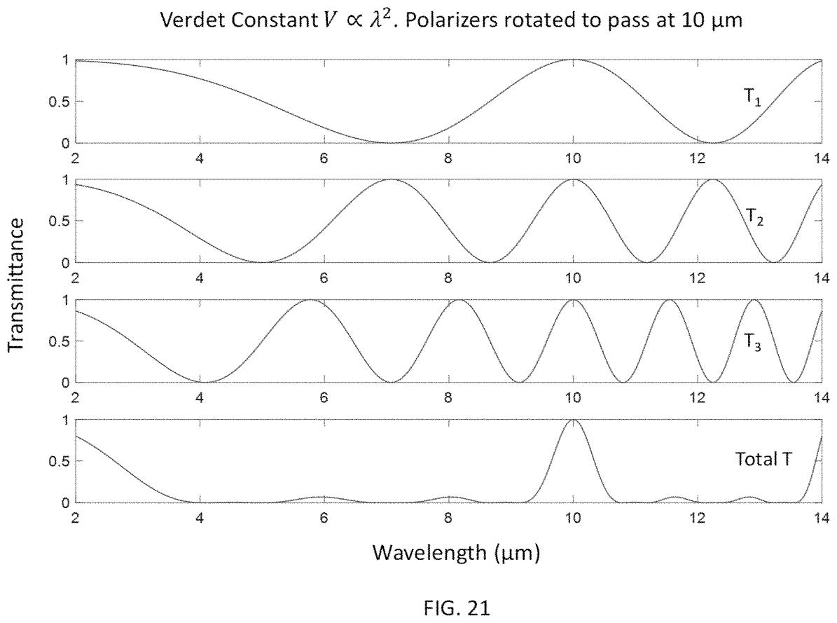

FIG. 21 shows the transmittances versus wavelength for the embodiment in FIG. 19 when the polarizers are rotated to pass light around λ=12 μm, assuming V∝λ² as in highly doped semiconductors. It is assumed that the combination of (B₁, B₂, B₃) and (L₁, L₂, L₃) are chosen so that the first stage rotates light polarization by the amount θ₁=aλ², the second stage rotates light polarization by the amount θ₂=2aλ², and the third stage rotates light polarization by the amount θ₃=3aλ², where a=π/100 rad/μm².

Note that in other embodiments the amount of rotation in each stage can be different from those illustrated in FIG. 20 and FIG. 21.

In addition to purely relying on MO materials to provide the dispersion in polarization needed for spectral filtering, other dispersive birefringent materials can be added into each unit stage. For example, birefringent materials such as waveplates also rotate/change the polarization state of light and have wavelength dependence.

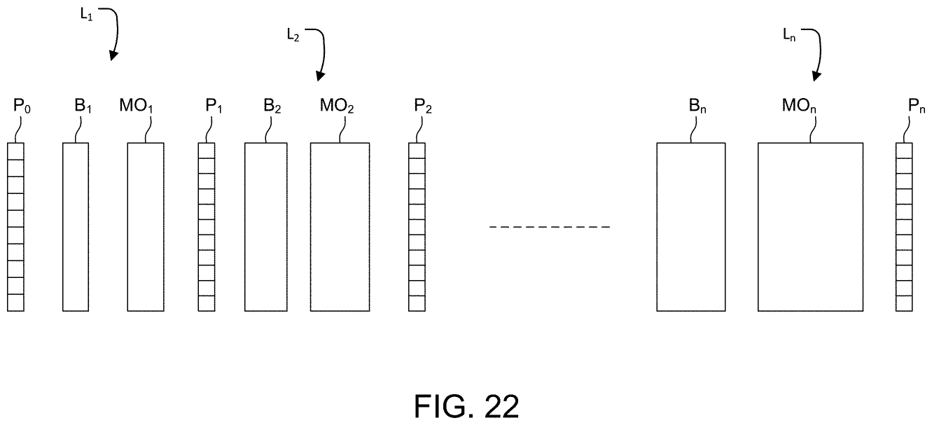

FIG. 22 shows one embodiment of an n-stage filter where in addition to the MO media M₁, M₂, . . . , and Mₙ, birefringent media B₁, B₂, . . . , and Bₙ are added to each dispersive element L to come before the MO media. The birefringent media can pre-set the filter to pass at a certain wavelength, and the MO sections can be used to tune the filter wavelength with magnetic field. In this configuration the requirement for magnetic field strength will be lowered.

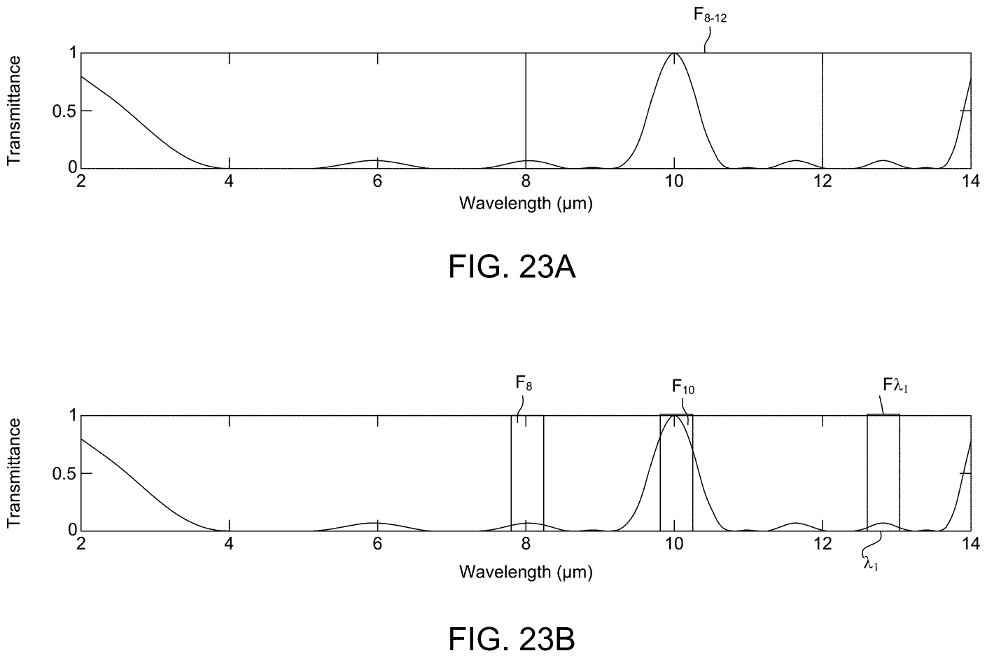

Additional fixed optical filters including long-pass, short-pass, band-pass and notch filters, can be added into the system. FIGS. 23A and 23B show examples of additional fixed wideband and/or narrowband filters added to the system for further filtering of the light. In FIG. 23A, F8-12 is a wide band filter that passes only the 8-12 μm LWIR band; in FIG. 23B, the fixed filters result in multiple narrow passbands F8, F10 and Fλ1, and the tunable filter 200 will tune which passband to go through.

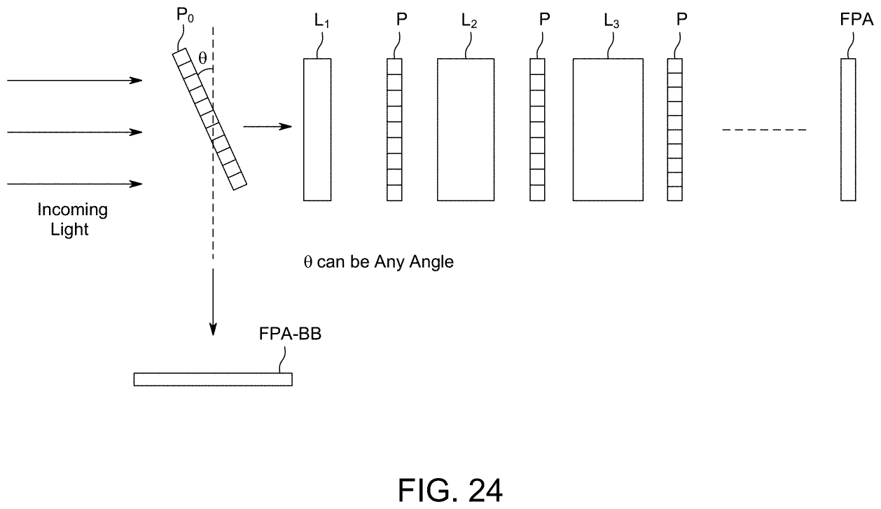

As shown in FIG. 7, the imaging system can capture the broadband image of the target at B=0 if the polarizers are not crossed. FIG. 24 shows an embodiment of the imaging system that can capture the broadband image alternatively. It uses a reflective front polarizer P₀ that is tilted from normal, such as at 45 degrees, to reflect light of the otherwise unused polarization to a focal plane array FPA-BB to form a simultaneous broadband grayscale image in addition to the final filtered image. The light reflected by P₀ would have the opposite polarization as the light transmitting P₀. Note that for randomly polarized incoming light, the optical power reaching FPA-BB would be roughly half of the total optical power.

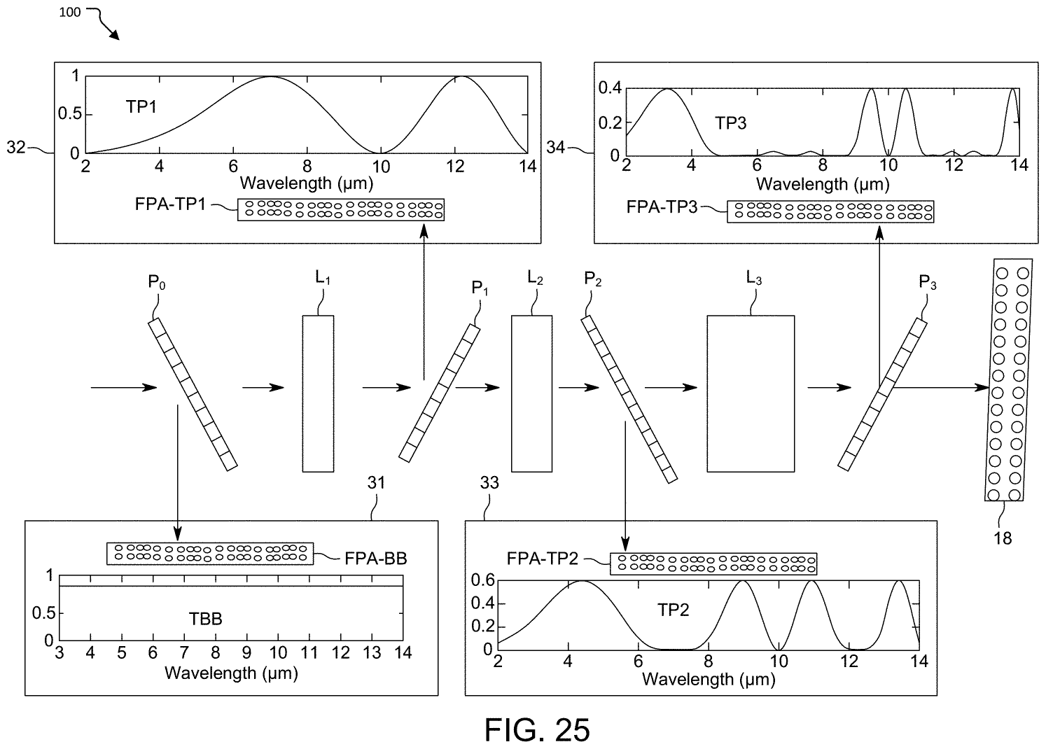

FIG. 25 is an embodiment where some or all polarizers are reflective, specifically, beam splitting polarizers, that reflect light of one polarization and transmit light of the opposite polarization. The polarizers P reflect incident light off at an angle to corresponding focal plane arrays for additional images while letting the remainder of light pass through as before for wavelength selection for narrowband imaging.

Each polarizer P is a reflective or beam-splitting polarizer that reflects light for additional images as shown in insets 31, 32, 33 and 34. The initial polarizer P₀ partially reflects light to a focal plane array FPA-BB in box 31 to form a broadband image as in FIG. 24.

Reflection off polarizer P₁ will be 1−T₁, where T₁ is the transmittance of the first stage. The reflected light is shown to be imaged using focal plane array FPA-TP1 in box 32.

Reflection off polarizer P₂ will be T₁×(1−T₂), where T₁ is the transmittance of the second stage. The reflection off P₂ is imaged on focal plane array FPA-TP2 shown in box 33.

Similarly, reflection off polarizer P₃ will be T₁×T₂×(1−T₃), where T₃ is the transmittance of the third stage. Refection off P₃ is imaged in the focal plane array FPA-TP3 as shown in box 34.

The light that is not reflected by the polarizers and thus not imaged on the focal plane arrays FPA-BB, FPA-TP1, FPA-TP2 and FPA-TP3, passes through the entire filter and is imaged by the focal plane array 18 as shown here and in FIG. 24.

The advantage of the embodiment of FIG. 25 is that broadband and narrow band images can be obtained by the same imaging set up, and in addition to imaging at the desired wavelength, images that block the desired wavelength can also be obtained.

It should be appreciated, that in the preferred embodiment, the present system is an imaging system that provides for angular resolution or spatial resolution. The focal plane arrays each resolve spatially.

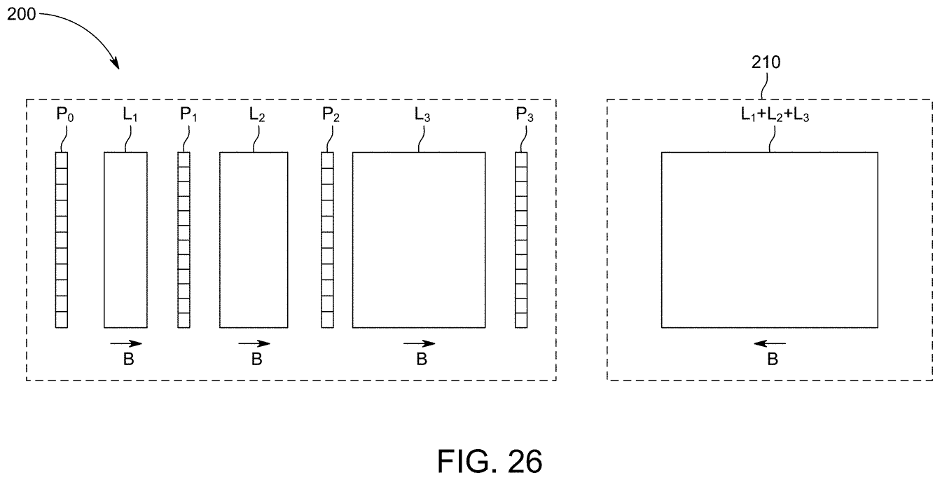

FIG. 26 shows a method that can be used to undo the image distortion caused by the dispersive elements. This figure shows that device 210 can undo this distortion. The device 210 is a single dispersive element equal in thickness to the sum of the three dispersive elements L₁, L₂, L₃ of filter 200. The filtered beam is passed through this distortion correcting dispersive element 210, which has a length that is equal to the lengths of the dispersive elements of the filter, L₁+L₂+L₃ with a magnetic field that is equal to but opposite of the B-field of the filter 200.

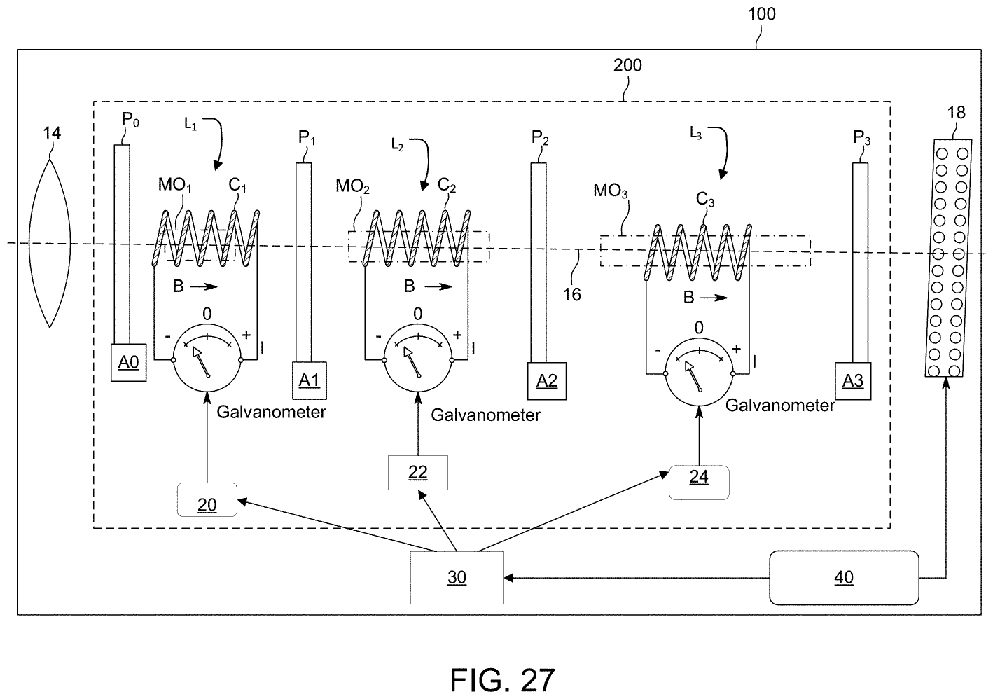

FIG. 27 is a system level diagram for the imaging system 100 shown in FIG. 5. The dispersive magneto-optic media MO₁, MO₂, MO₃ are encircled in coils C₁, C₂ and C₃, respectively, each carrying current I and inducing a magnetic field of strength B. This provides the respective dispersive elements L₁, L₂ and L₃. I and B are equal for L₁, L₁ and L₃, in one embodiment, while they can be different in other cases. The power supplies 20, 22 and 24 are controlled by controller 30. Current can be adjusted to ensure that the desired wavelength is rotated 180°, 360° and 540° by dispersive elements L₁, L₂ and L₃, respectively. Dispersive elements L₂ and L₃ are 2 and 3 times the length of polarizer L₁. This amount of rotation will allow the desired wavelength to pass through the vertical polarizers P₁, P₂ and P₃ unattenuated. P₀, which is also a vertical polarizer, sets the initial polarization to vertical. The lens 14 collimates emitted radiance from the target before entrance to P₀.

The FPA 18 receives light upon exit from the last polarizer P₃. The master controller 40 of the imaging system 100 also controls the EPA 18, in addition to controlling the power supply controller unit 30 which powers the coils C₁ (using power supply unit 20), C₂ (using power supply unit 22) and C₃ (using power supply unit 24) of the filter 200.

In one mode of operation, the master controller 40, tuning the filter 200 by controlling the current to each of the coils C₁, C₂ and C₃ via power supply controller unit 30, also captures the images of the scene via the focal plane array 18 at different wavelengths. These ‘images’ are often combined to form a three-dimensional, in (x,y,λ), hyperspectral data cube for processing and analysis, where x and y represent two spatial dimensions of the scene, and λ represents the spectral dimension (comprising a range of wavelengths). In one example, the array has greater than 320×240 pixels, preferably equal to or greater than 1024×768 pixels.

In addition, the master controller 40, also preferably tunes the filter 200 by controlling actuators A0, A1, A2, A3 that individually control the angle of each of the polarizers P₀, P₁, P₂ and P₃.

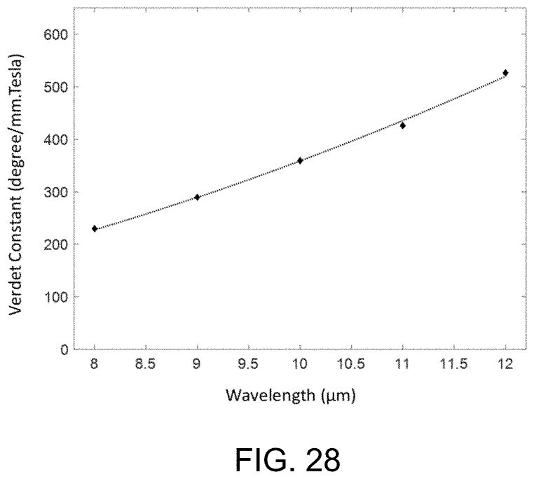

FIG. 28 shows the Verdet constant, degrees/mm.Tesla, as a function wavelength in micrometers. It is for highly-doped InSb (Te-doped, n-type, doping concentration ≈9E17 cm⁻³) at room temperature. The dots are measured data and the dashed line is the quadratic fitting of the data with the formula V=3.66*λ²−7.12, where V is the Verdet constant with unit of degree/(mm.Tesla) and λ is the wavelength with unit of micrometers.

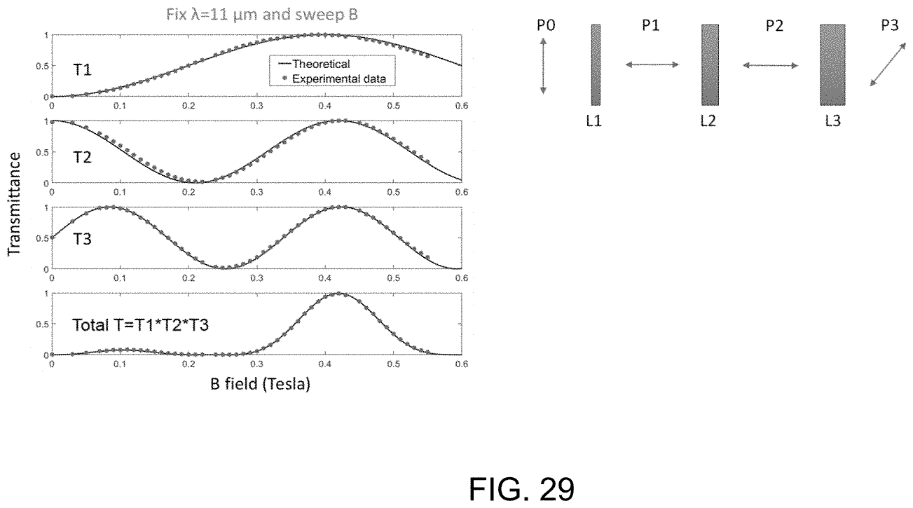

FIG. 29 are plots of transmittance as a function of B field for an experimental demonstration of a 3-stage filter with a laser at fixed wavelength λ=11 μm while scanning the B field.

The dots are measured transmittance data and the curves are theoretical calculation based on the measured Verdet constants of dispersive elements L₁, L₂ & L₃. Material losses are not included. T₁, T₁ & T₃ all have transmittance maxima around 0.42 Tesla which results in a single peak around 0.42 Tesla for total T. Dispersive elements L₁, L₂, L₃ are constructed from highly-doped InSb magneto-optic media with doping levels on the order of E17 cm⁻³. Data were taken at room temperature.

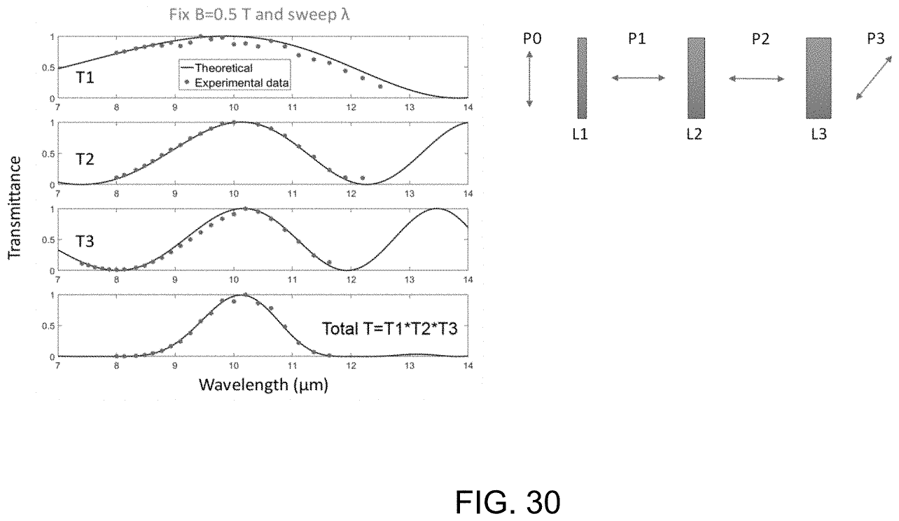

FIG. 30 are plots of transmittance as a function of B field for an experimental demonstration of a 3-stage filter with a laser at fixed wavelength λ=11 μm while B=0.5 Tesla.

The dots are measured transmittance data and the curves are theoretical calculation based on the measured Verdet constants of dispersive elements L₁, L₂ & L₃. Material losses are not included.

T₁, T₂ & T₃ all have transmittance maxima around λ=10 μm which results in a single peak around λ=10 μm for total T. Dispersive elements L₁, L₂, L₃ are all highly-doped InSb with doping levels on the order of E17 cm⁻³. Data were taken at room temperature.

While this invention has been particularly shown and described with references to preferred embodiments thereof, it will be understood by those skilled in the art that various changes in form and details may be made therein without departing from the scope of the invention encompassed by the appended claims.

What is claimed is:

1. An optical filter comprising a dispersive polarization-rotating medium, wherein the filter is a spectral filter.

2. An optical filter as claimed in claim 1, wherein the dispersive polarization-rotating medium comprises magneto-optic material.

3. An optical filter as claimed in claim 2, wherein the central wavelength and/or the bandwidth of the filter is tuned by a magnetic field applied to the magneto-optic material.

4. An optical filter as claimed in claim 2, further comprising one to many stages of polarizers and dispersive magneto-optic materials.

5. A tunable spectral filter comprising:
one or more stages of polarizers and dispersive magneto-optic material; and
a tunable magnetic field source generating a magnetic field, wherein the central wavelength and/or the bandwidth is tuned by the magnetic field.

6. An optical filter as claimed in claim 5, wherein the magnetic field source is an electromagnetic source and the magnetic field strength is tuned electrically.

7. An optical filter as claimed in claim 5, wherein the magnetic field source comprises permanent magnets and the magnetic field is tuned by varying the distance between the magnets and the materials.

8. An optical filter as claimed in claim 5, wherein the magnetic field source comprises a combination of electromagnets and permanent magnets.

9. An optical filter as claimed in claim 5, wherein the magnetic field source is magnetic thin films deposited on the magneto-optic materials, and the magnetic field is tuned by electromagnets or permanent magnets.

10. An optical filter as claimed in claim 5, wherein the central wavelength of the filter is tuned by the angle of one or more polarizing elements.

11. An optical filter as claimed in claim 10, wherein the dispersive polarization-rotating medium comprises magneto-optic material and a magnetic field is applied to the medium.

12. A tunable spectral filter comprising:
one or more stages of polarizers and dispersive polarization-rotating media, wherein the central wavelength and/or the bandwidth of the filter is tuned by the angle of one or more of the polarizers.

13. An optical system comprising:
a tunable spectral filter including:
one or more stages of polarizers and dispersive magneto-optic materials; and
a tunable magnetic field source generating a magnetic field for the dispersive magneto-optic materials;
wherein a central wavelength and/or a bandwidth of the filter is tuned by the magnetic field.

14. A system as claimed in claim 13, wherein the magnetic field source is an electromagnetic source and the magnetic field strength is tuned by electrical means.

15. A system as claimed in claim 13, wherein the magnetic field source comprises permanent magnets and the magnetic field is tuned by varying the distance between the magnets and the materials.

16. A system as claimed in claim 13, wherein the magnetic field source is a combination of electromagnets and permanent magnets.

17. A system as claimed in claim 13, wherein the magnetic field source comprises magnetic thin films deposited on the magneto-optic materials, and the magnetic field is tuned by electromagnets or permanent magnets.

18. A system as claimed in claim 13, further comprising dispersive birefringent materials in the tunable spectral filter.

19. A system as claimed in claim 13, further comprising collection optics including lenses and/or mirrors for collecting light for filtering by the tunable spectral filter.

20. A system as claimed in claim 13, further comprising active light sources including lasers and/or lamps for illuminating a scene.

21. A system as claimed in claim 13, further comprising one or more photodetectors for detecting light from the filter.

22. A system as claimed in claim 13, further comprising one or more focal plane arrays (FPA) for detecting light from the filter.

23. A system as claimed in claim 13, further comprising reflective polarizers and multiple focal plane arrays for detecting light at the different stages of the filter.

24. A system as claimed in claim 13, further comprising one or more fixed spectral filters in conjunction with the tunable spectral filter.

25. A system as claimed in claim 24, wherein the fixed spectral filters are long-pass, low-pass, bandpass or notch filters.

26. An optical system comprising:
a tunable spectral filter comprising:
one or more stages of polarizers and dispersive polarization-rotating media;
wherein the central wavelength and/or the bandwidth of the filter is tuned by the angle of one or more of the polarizers.

27. A system as claimed in claim 26, wherein the dispersive polarization-rotating media comprises magneto-optic materials and a magnetic field is applied to the media.

28. A system as claimed in claim 26, further comprising collection optics including lenses and/or mirrors.
